(19) United States
(12) Patent Application Publication
(10) Pub. No.: US 2026/0011093 A1
(43) Pub. Date: Jan. 8, 2026

(54) SYSTEMS AND METHODS FOR IDENTIFYING A TARGETED OBJECT FOR AI-ASSISTED INTERACTIONS USING A HEAD-WEARABLE DEVICE

(71) Applicant: Meta Platforms Technologies, LLC, Menlo Park, CA (US)

(72) Inventors: Helia Rahmani, Mountain View, CA (US); Saara Khan, Cupertino, CA (US); Stephen McClure, San Carlos, CA (US); Brian Keith Cabral, San Jose, CA (US); Mahima Gupta, Brisbane, CA (US)

(21) Appl. No.: 19/257,386

(22) Filed: Jul. 1, 2025

Related U.S. Application Data
(60) Provisional application No. 63/667,115, filed on Jul. 2, 2024.

(51) Int. Cl. G06T 19/00; G02B 27/01; G06F 3/01; G06V 10/25; G06V 40/16

(52) U.S. Cl. CPC G06T 19/006; G02B 27/017; G06F 3/012; G06F 3/013; G06F 3/017; G06V 10/25; G06V 40/161; G06V 2201/07

(57) ABSTRACT

System and method for using an artificial intelligence (AI) system of a head-wearable device to process image data using eye-tracking data are disclosed. An example method includes, in accordance with an indication that first data captured by the head-wearable device satisfies an AI assistant trigger condition, initiating the AI assistant and capturing, by the head-wearable device, second data and field-of-view (FOV) image data. The example method includes determining, by the AI assistant, a user query and contextual information based on the second data and the FOV image data. The example method includes detecting, based on the user query and the contextual information, a portion of the FOV image data including an object of interest; and performing a context-based command on the portion of the FOV image data including the object of interest. The context-based command is based on one or more of the contextual information and the user query.

### RELATED APPLICATION

This application claims priority to U.S. Provisional Application Ser. No. 63/667,115, filed Jul. 2, 2024, entitled “Eye Tracking In Non-Display Smart Glasses For Use In Identifying A Targeted Object For AI-Assisted Interactions, And Methods Of Use Thereof,” which is incorporated herein by reference.

### TECHNICAL FIELD

This relates generally to artificial intelligence assistants and, more specifically, artificial intelligence assistants for use with head-wearable device, such as augmented reality glasses with or without a display.

### BACKGROUND

Currently eye tracking is used on devices including immersive display systems. The immersive display systems allow for higher levels of display engagement by using eye tracking and gaze tracking. Explorations on the use of eye tracking for use in artificial-intelligence (AI) assisted interactions (particularly for devices lacking a display, but also for other devices) has been very limited.

As such, there is a need to address one or more of the above-identified challenges. A brief summary of solutions to the issues noted above are described below.

### SUMMARY

One example head-wearable device is described herein. The example head-wearable device includes one or more sensors, one or more imaging devices (e.g., cameras), and one or more programs. The one or more programs are stored in memory and are configured to be executed by one or more processors of the head-wearable device. The one or more programs include instructions for performing, in accordance with an indication that first data captured by the head-wearable device satisfies an artificial intelligence (AI) assistant trigger condition, initiating the AI assistant; capturing, by the head-wearable device, second data; and capturing field-of-view (FOV) image data using an imaging device of the head-wearable device. The one or more programs include instructions for performing determining, by the AI assistant, a user query and contextual information based on the second data and the FOV image data. The one or more programs include instructions for performing detecting, based on one or more of the user query and the contextual information, a portion of the FOV image data including an object of interest. The one or more programs include instructions for causing performance of a context-based command on the portion of the FOV image data including the object of interest, wherein the context-based command is based on one or more of the contextual information and the user query.

Another example of a displayless head-wearable device is described herein. This other example displayless head-wearable device includes one or more sensors, one or more imaging devices, and one or more programs. The one or more programs are stored in memory and are configured to be executed by one or more processors of the head-wearable device. The one or more programs including instructions for performing, in response to a first input initiating an artificial intelligence (AI) assistant, capturing, via an eye-tracking imaging device of a displayless head-wearable device, eye-tracking image data. The one or more programs including instructions for performing determining, by the AI assistant using the eye-tracking image data, gaze data for at least one eye of a wearer of the displayless head-wearable device, and obtaining field of view (FOV) image data for the displayless head-wearable device. The one or more programs including instructions for performing, responsive to a second input associated with a command, determining, based on the gaze data, a portion of the FOV image data associated with the second input and causing the AI assistant to perform the command using the portion of the FOV image data.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates image data segmentation based on eye-tracking data for at least one eye of a wearer of a head-wearable device, in accordance with some embodiments.

FIGS. 2A-2C illustrate different use cases of an AI assistant using eye-tracking data, in accordance with some embodiments.

FIG. 3 illustrates image data segmentation based on head-orientation data for a wearer of a head-wearable device, in accordance with some embodiments.

FIG. 4 illustrates different use cases of an AI assistant using head-orientation data detected at a head-wearable device, in accordance with some embodiments.

FIG. 5 shows an example method flow chart for using, by an AI assistant, eye-tracking data detected at a head-wearable device, in accordance with some embodiments.

FIG. 6 shows an example method flow chart for using data captured by the head-wearable device to initiate and use an AI assistant, in accordance with some embodiments.

FIGS. 7A-7C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

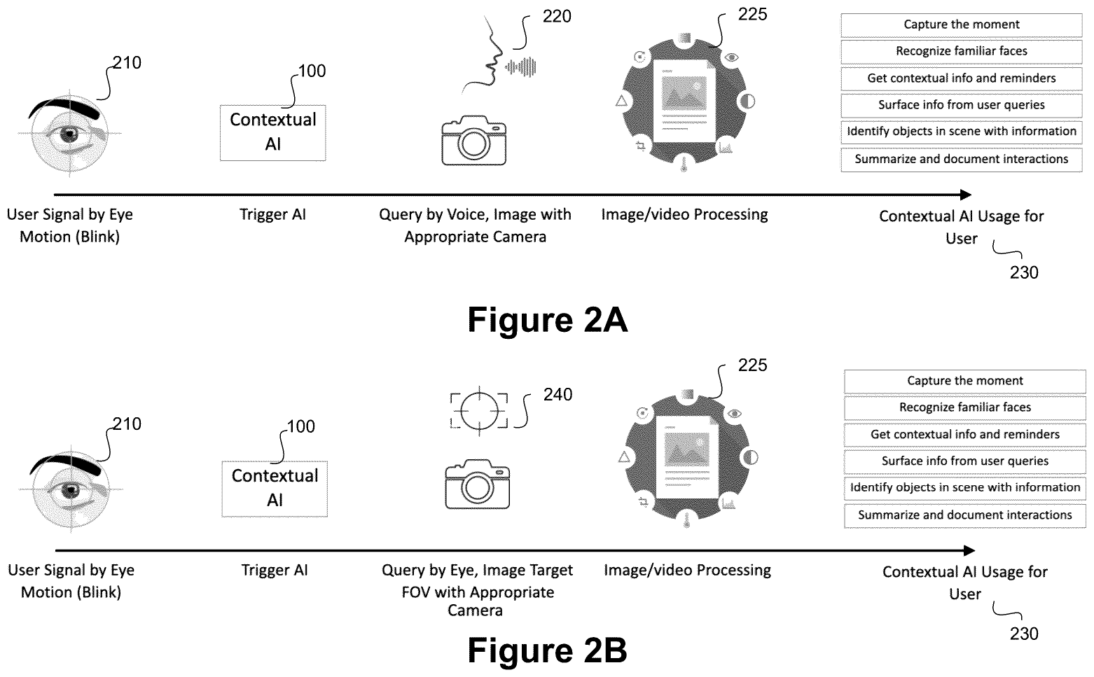

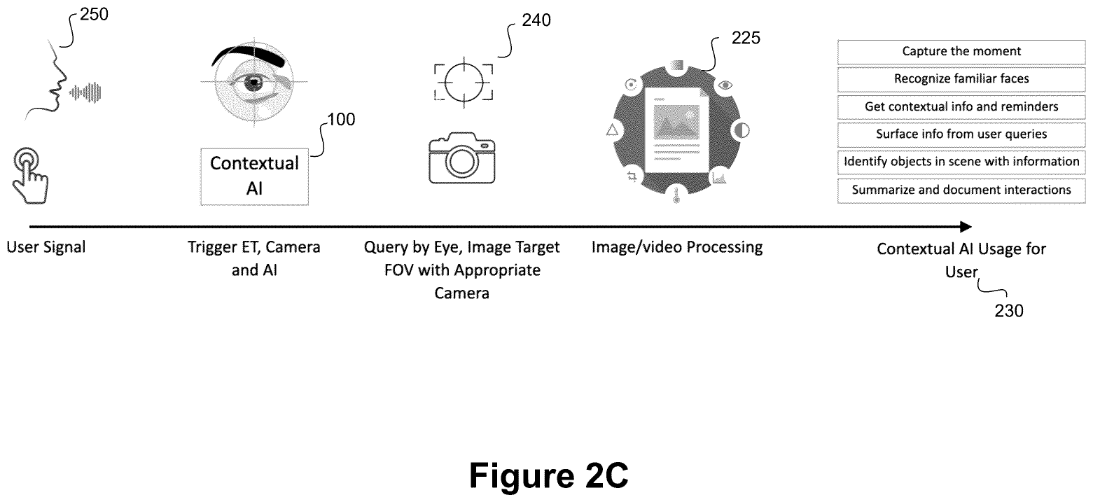

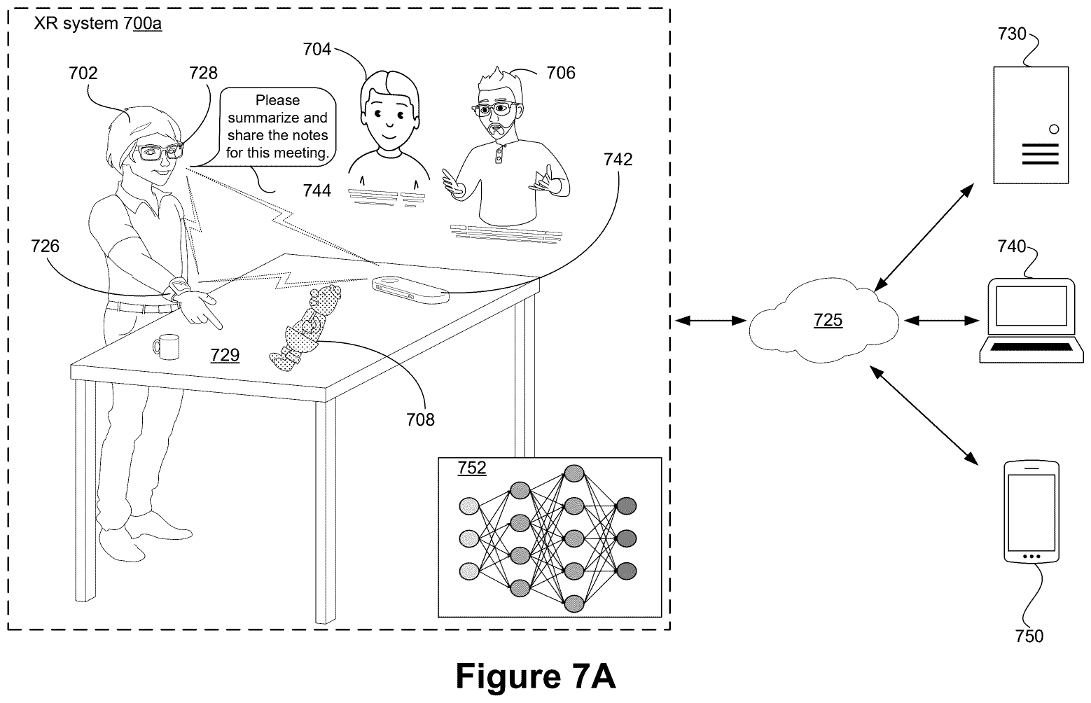

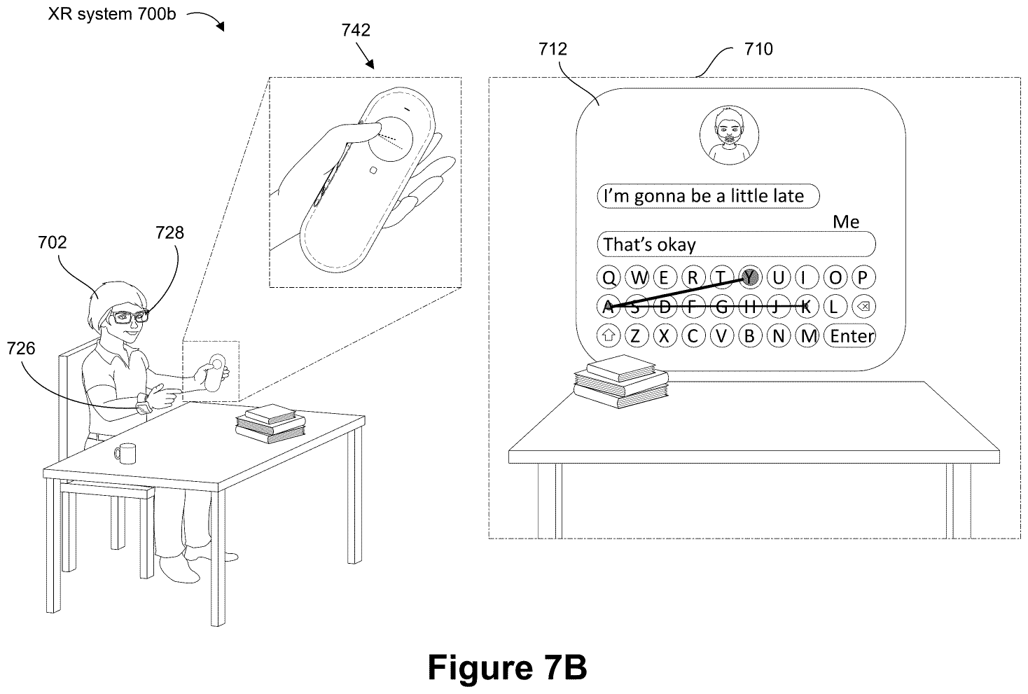

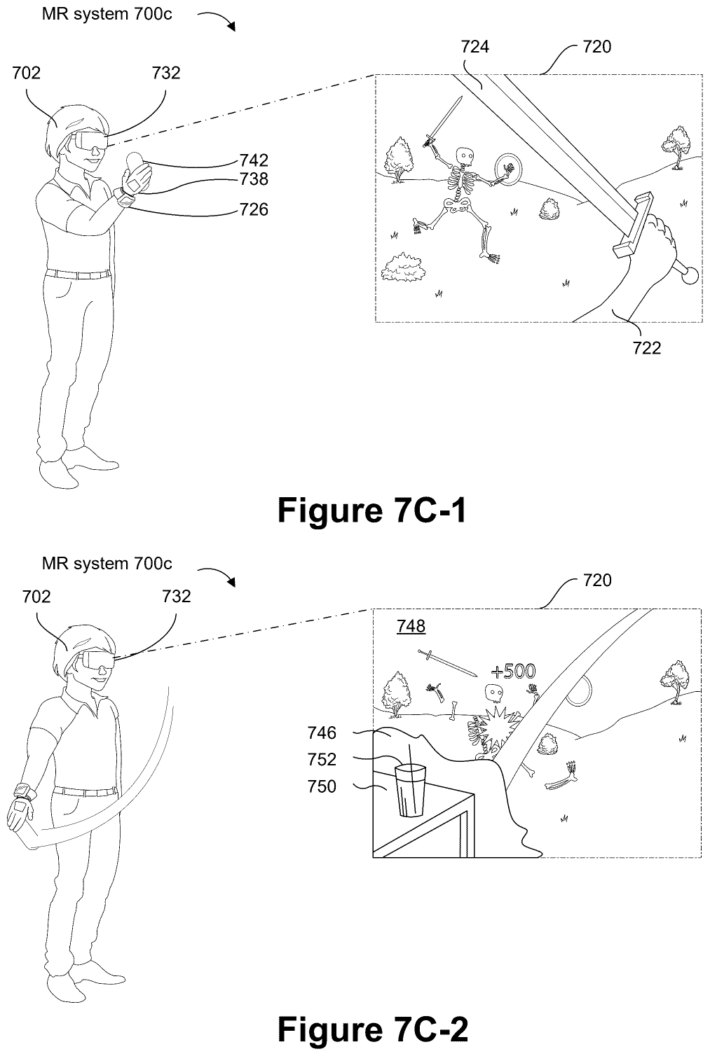

The systems and methods disclosed herein enable AI interaction at a displayless head-wearable device (e.g., non-display AI Smart Glasses, non-display AR device, and/or other AR device described below in reference to FIGS. 7A-7C-2) using eye tracking (ET). The systems and methods disclosed herein enable a user (e.g., a wearer of a head-wearable device) to look at an object and trigger or interact with AI assistant, without having to point or describe the object. The systems and methods disclosed herein use ET image data to identify intent based contextual AI use-cases (e.g., operations performed by an AI assistant based on contextual cues interpreted from a user's gaze or focus). The systems and methods disclosed herein improve accessibility and usability of wearable devices (e.g., by providing wearable devices with lower power requirements, reduced thermal constraints due to displays, reduced weight, etc.).

Non-limiting examples of the contextual AI use-cases performed by the AI assistant included in the displayless head-wearable device include capturing a moment of interesting and exciting events, recognizing familiar faces, understanding context from surroundings to provide information and reminders, surfacing appropriate information from queries, identifying objects in a scene and reacting with key information, summarizing content and/or performing document interactions. The use of ET as the input for the AI assistant has many advantages, such as obviating the need for voice activated audio descriptions, hand gestures, or auxiliary controllers to trigger the AI assistant; and/or providing input to identify the object, scene, or additional use-cases of interest with which the user wants the AI assistant's help.

### Eye-Tracking Data Based AI Scene Segmentation

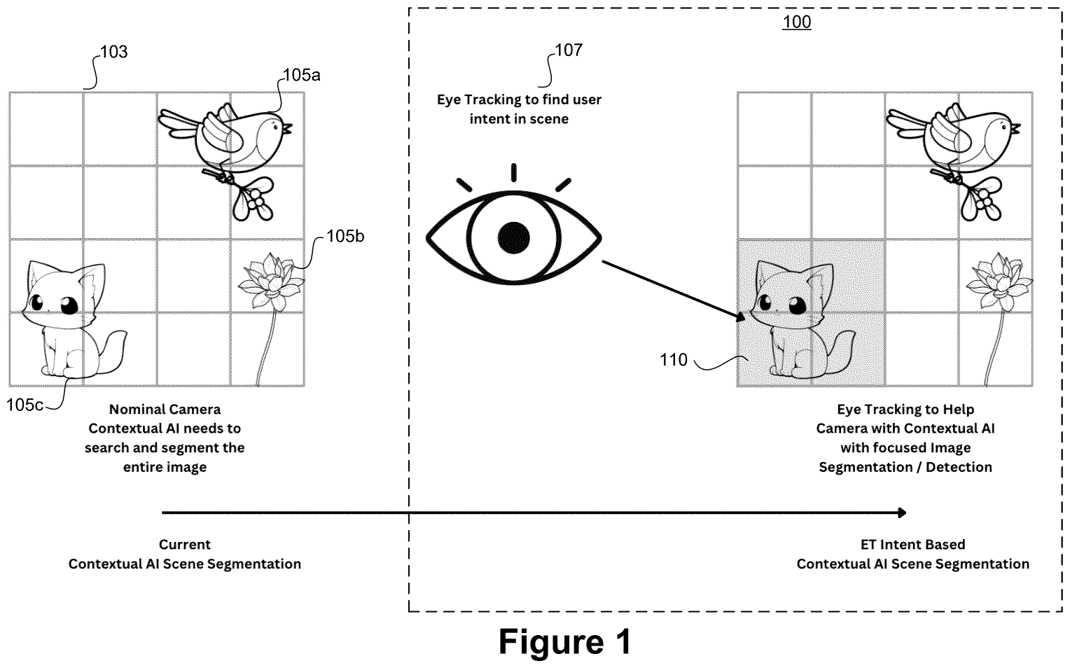

FIG. 1 illustrates image data segmentation based on ET data for at least one eye of a wearer of a head-wearable device, in accordance with some embodiments. In particular, FIG. 1 show the advantages of incorporating ET based user intent for an imaging device (e.g., a camera) based AI system 100 (e.g., a contextual AI system) for scene detection and segmentation. Existing systems (show outside of the dotted box) require an entire image 103 including one or more objects (e.g., a first object 105a, a second object 105b, and a third object 105c) to be searched and segmented. In contrast, the AI system 100 (as disclosed herein) is able to detect a targeted region 110 and focus segmentation and detection on the targeted region 110.

The AI system 100 can be used or incorporated in any head-wearable device shown and described below in reference to FIGS. 7A-7C-2, such as an AR device 728 and an MR device 732. In some embodiments, the AI system 100 is used or incorporated in a displayless head-wearable device. In some embodiments, the AI system 100 can be used in any electronic device that is configured to provide image data to the AI system 100 for processing. The head-wearable device (or other electronic devices) includes an ET module for capturing ET data 107.

The ET data can include, without limitation, gaze information (e.g., gaze direction, gaze changes, saccades, etc.) and eye-motion data (e.g., eye blinks, blinking patterns, gawking, goggling, staring, etc.). Non-limiting examples of gaze information includes depth, orientation, and duration of gaze or pupil size. In some embodiments, the gaze information is used, by the AI system 100, to help identify objects, scenes, targeted field of views (FOV) and/or a user's interest level. The gaze information can also inform AI scene segmentation as well as provide opportunities to decrease the power consumption, reduce data size, and improve segmentation/detection accuracy through targeted FOV (e.g., targeted region 110). Non-limiting examples of eye-motion data includes different sequences of blinking and/or squinting. As described below in reference to FIGS. 2A and 2B, the eye-motion data can be used to trigger or initiate the AI system 100 and/or provide one or more action commands to the AI system 100. For example, a double-blink can be used to activate an AI assistant that is part of the AI system 100.

### AI Triggers and Eye-Tracking Data Based Context Determinations

FIGS. 2A-2C illustrate different use cases of an AI assistant using eye-tracking data, in accordance with some embodiments. In particular, FIGS. 2A-2C illustrate different triggers for providing ET data (e.g., the gaze information and eye-motion data) to the AI system 100 of a head-wearable device. As described above, the head-wearable device can be an AR device 728 and/or an MR device 732 described below in reference to FIGS. 7A-7C-2. In some embodiments, the head-wearable device is displayless (e.g., a displayless AR device or displayless smart glasses).

In some embodiments, the AI system 100 is initiated in response to a first input. The first input can be one or more of a hand gesture, an ET gesture (e.g., a blink, a squint, a blink gesture, a squint gesture, etc.), a voice command, a device input, etc. When the AI system 100 is initiated, the head-wearable device captures, via an ET module of the head-wearable device ET data. The ET data includes a representation of an eye-centric scene and is used for providing gaze information and eye-motion data to the AI system 100. The ET data can be processed by the head-wearable device to determine the gaze information and eye-motion data. Alternatively, or in addition, the AI system 100 can process the ET data to determine the gaze information and eye-motion data. The AI system 100 determines ET data for at least one eye of a wearer of the head-wearable device (e.g., contextual gaze cues). The AI system 100 further obtains FOV image data for the head-wearable device (e.g., captured using a FOV camera for the head-wearable device, which can include a representation of a world-centric scene of the head-wearable device).

In some embodiments, the head-wearable device, responsive to a second input associated with a context-based command, determines, based on the ET data, a portion of the FOV image data (e.g., targeted region 110; FIG. 1) associated with the second input, and causes the AI assistant 100 to perform the context-based command using the portion of the FOV image data. The second input can be a user query provided via one or more of a hand gesture, an ET gesture (e.g., blinks or squints), a voice command, a device input, etc. The context-based command can include, without limitation, any usage case shown in contextual AI usage cases 230. For example, the context-based commands can include one or more of capturing world-centric scene included in the FOV image data; detecting faces within the portion of the FOV image data; determining additional contextual information from the portion of the FOV image data; providing reminders based on the portion of the FOV image data; determining surface information; identifying the object of interest within the portion of the FOV image data; and performing document-specific operations.

Turning to FIG. 2A, a first embodiment for initiating the AI system 100 is shown. A first trigger 210 can include ET gestures, such as a predetermined number of eye blinks (or squints) and/or eye motions (e.g., saccades). The predetermined number of eye blinks when detected initiate the AI system 100. The AI system 100, in conjunction with being initiated, receives the ET data via the ET module of the head-wearable device. The AI system 100 further receives, FOV image data from an imaging device of the head-wearable device such that the FOV image data can be processed as described herein (e.g., segmentation and detection). While the AI system 100 is initiated, a wearer of the head-wearable device can interact with head-wearable device using a first set of inputs 220, such as a voice command, a hand gesture, a device input, and/or other inputs described herein. The FOV image data is processed (as shown by operation 225), based on the user input and the AI assistant 100 performs a contextual AI use-case operation (as shown by contextual AI usage cases 230).

In the first embodiment for initiating the AI system 100, a low-power ET module is always active for detecting the first trigger 210 (e.g., to detect motion, such as different numbers of blinks or squints).

Turning to FIG. 2B, a second embodiment for initiating the AI system 100 is shown. The second embodiment for initiating the AI system 100 uses the first trigger 210 to initiate the AI system 100. The second embodiment for initiating the AI system 100 allows a wearer of the head-wearable device to interact with head-wearable device using a second set of inputs 240, such as a gaze inputs and/or ET data. The AI system 100 uses the gaze inputs as a guide for performing one or more context-based commands. For example, the gaze inputs can be used to identify the targeted region 110 and/or a targeted (animate or inanimate) object. When the ET module is used for capturing the second set of inputs 240, the ET module can be operated in a high-power mode (or a high-power ET module can be used).

In the second embodiment for initiating the AI system 100, a low-power ET module with high accuracy is always active such that it can provide accurate data for performing the different contextual AI use-case operations (as shown by contextual AI usage cases 230).

Turning to FIG. 2C, a third embodiment for initiating the AI system 100 is shown. The third embodiment for initiating the AI system 100 uses a second trigger 250 for initiating the AI system 100. The second trigger 250 for initiating the AI system 100 includes one or more of a voice command, a hand gesture, and/or a device input (e.g., a button press, a cap sensor detection, etc.). The AI system 100, when initiated, receives the ET data. Similar to the second embodiment for initiating the AI system 100, the third embodiment for initiating the AI system 100 uses the second set of inputs 240 and performs one or more context-based commands based on user inputs.

In the third embodiment for initiating the AI system 100, an ET module is not always active, which reduces power requirements.

The different interaction embodiments described above provide flexibility in reducing the power requirements and sensor usage (e.g., active or inactive). By providing different methods of initiating the AI system 100, power consumption of the head-wearable device can be reduced. For example, the first embodiment for initiating the AI system 100 can used when low power consumption by the ET module is desired. The second embodiment for initiating the AI system 100 can used when higher power consumption is acceptable and improved accuracy is desired. Alternatively, the third embodiment for initiating the AI system 100 can used when the ET module is only used for providing gaze inputs to the AI system 100.

### Head-Orientation Data Based AI Scene Segmentation

In some embodiments, a head-wearable device can leverage existing sensors on to provide coarse-scene focus for the contextual AI features. Coarse-scene focus for the contextual AI features is advantageous for creating a personal timeline for a user and their interests throughout the day. In some embodiments, the systems and methods disclosed herein can utilize existing sensors, such as IMUs (which can be coarse), and region-based image to determine an understanding of where a user is looking at in a scene. In some embodiments, the systems and methods disclosed herein use one or more IMUs and a (point of view (POV)) imaging device to implement a coarse scene focus. In some embodiments, the systems and methods disclosed herein utilize a low power sensor (e.g., an IMU) to help us understand objects and people of focus throughout the day that are related to the contextual AI needs without increasing system complexity. In some embodiments, the systems and methods disclosed herein allow for the processing of less pixels per image when implementing an always-on or sometimes-on imaging device process for contextual AI learnings on the user, decrease the power needed per image for contextual AI images and segmentations, and decrease the latency time for users to learn about or search through their image about things.

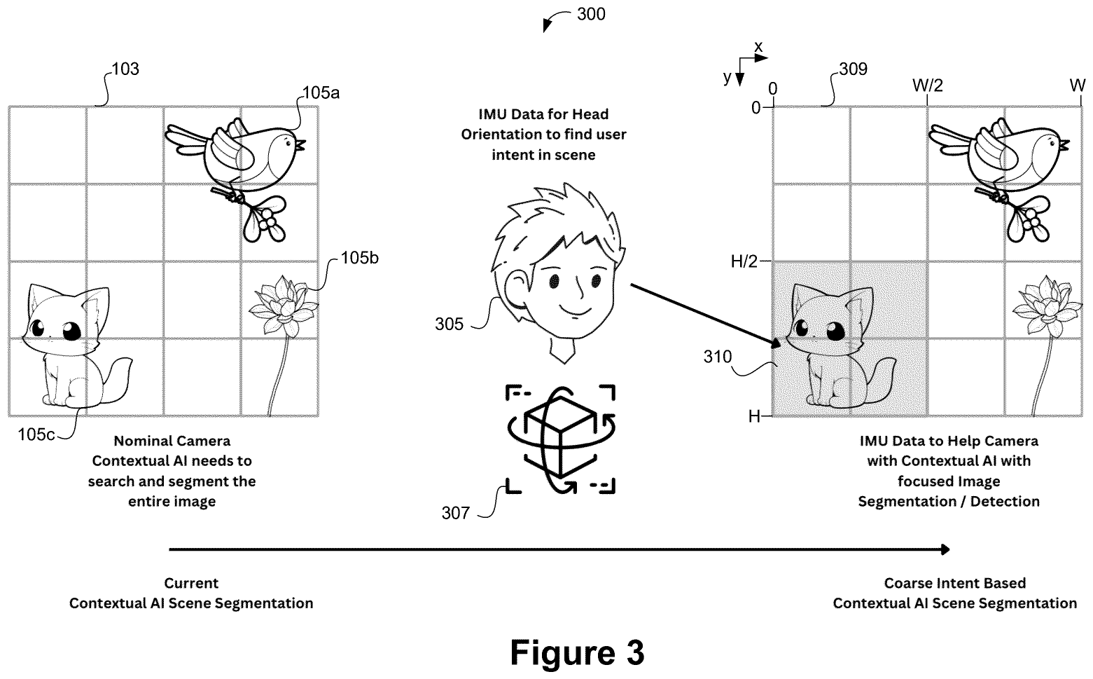

FIG. 3 illustrates image data segmentation based on head-orientation data for a wearer of a head-wearable device, in accordance with some embodiments. In particular, FIG. 3 show the advantages of using head orientation (e.g., captured using an IMU) based user intent for an imaging device based AI system 100 for scene detection and segmentation. In some embodiments, the head orientation based user intent is used with the ET based user intent described above in reference to FIGS. 1-2C. As described below, the AI system 100 including a head orientation based image segmentation process 300 can use the head-orientation data to detect another targeted region 310 (from within an entire image 103 including one or more objects (e.g., a first object 105a, a second object 105b, and a third object 105c)) and focus segmentation and detection on the other targeted region 310.

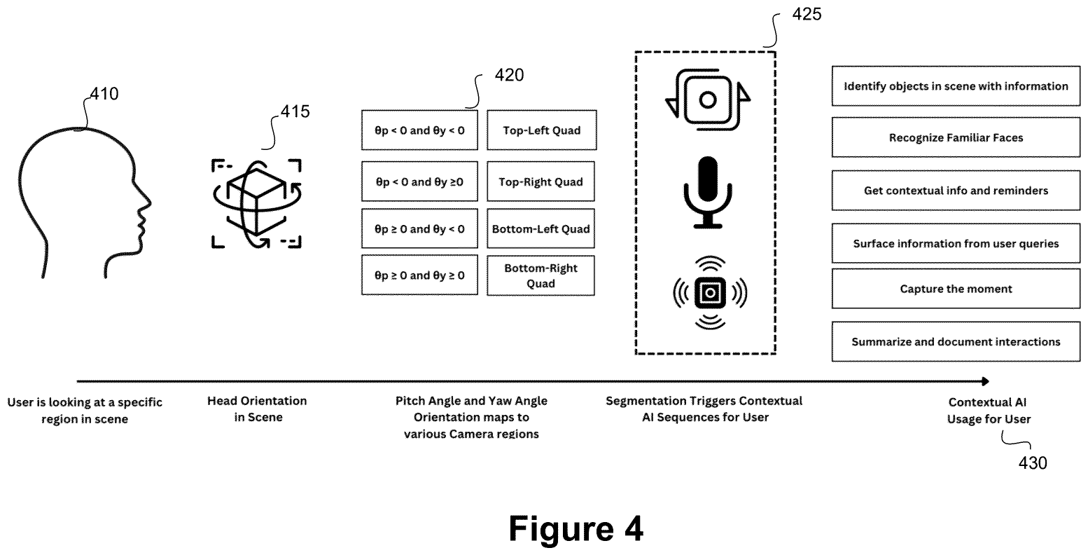

The head orientation based image segmentation process 300 (described in reference to FIGS. 3 and 4) can be used or incorporated in any head-wearable device shown and described below in reference to FIGS. 7A-7C-2, such as an AR device 728 and/or an MR device 732. In some embodiments, the head orientation based image segmentation process 300 is used or incorporated in a displayless head-wearable device. In some embodiments, the head orientation based image segmentation 300 can be used in any electronic device that is configured to provide image data to the AI system 100 for processing. The head-wearable device (or other electronic devices) can use existing sensors (IMUs) to capture head-orientation data 307 based on a head orientation 305 of a user wearing the head-wearable device.

The head orientation based image segmentation process 300 can be performed while a user is capturing image data using a head-wearable device (or other electronic device). The head orientation based image segmentation process 300 can be performed one or more image frames of the captured image data. The head orientation based image segmentation process 300 captures head-orientation data 307 using one or more sensors (IMUs) at the same time that the image data is captured. The head-orientation data 307 includes corresponding timestamps with the captured image data and is used to determine a user head angle at the time the image data capture was initiated. In some embodiments, an IMU has a predetermined refresh rate that is used to correlate accurate image capture data with IMU data (e.g., head-orientation data 307). In some embodiments, the predetermined refresh rate of an IMU is between 25 Hz-1000 Hz. In some embodiments, the predetermined refresh rate of an IMU is 50 Hz, 100 Hz, 250 Hz, 500 Hz, 1000 Hz, and/or other values. In some embodiments, the predetermined refresh rate of an IMU is based on the parameters of an imaging device.

The head orientation based image segmentation process 300, at a first point in time, obtains IMU data for a head orientation 305 of the user wearing the head-wearable device. The IMU data is represented by head-orientation data 307. The head-orientation data 307 (representative of a head orientation of the user) includes a pitch angle (θp) (which denotes an up-down tilt of the head (e.g., nodding the head up and down)) and a yaw angle (θy) (which denotes a left-right rotation of the head (e.g., shaking the head side to side to communicate no).

The head orientation based image segmentation process 300, at a second point in time, defines the image data 103 and divides the image data 103 into one or more quadrants (e.g., divided image data 309). For example, the image data 103 can have a predetermined width (W) and a predetermined height (H) and the head orientation based image segmentation process 300 can divide the image data 103 (to form the divided image data 309) into one or more quadrants (e.g., four quadrants). Any number of quadrants can be used based on how much resolution can be gained from the IMU head position tracking. For ease of discussion, the divided image data 309 can include a top-left quadrant (which corresponds to 0≤x<W/2 and 0≤y<H/2 of the image data 103), a top-right quadrant (which corresponds to W/2≤x<W and 0≤y<H/2 of the image data 103), a bottom-left quadrant (which corresponds to 0≤x<W/2 and H/2≤y<H of the image data 103), and a bottom-right quadrant (which corresponds to W/2≤x<W and H/2≤y<H of the image data 103).

The head orientation based image segmentation process 300, at a third point in time, maps the IMU data (e.g., the head-orientation data 307) to the divided image data 309. For example, a pitch angle (θp) and a yaw angle (θy) of the head-orientation data 307 can be mapped to one or more quadrants of the divided image data 309. By way of illustration, the top-left quadrant can correspond to the user looking up and to the left and can be mapped to pitch angles of θp<0 and yaw angles of θy<0; the top-right quadrant can correspond to the user looking up and to the right and can be mapped to pitch angles of θp<0 and yaw angles of θy≥0; the bottom-left quadrant can correspond to the user looking down and to the left and can be mapped to pitch angles of θp≥0 and yaw angles of θy≤0; and the bottom-right quadrant can correspond to the user looking down and to the right and can be mapped to pitch angles of θp≥0 and yaw angles of θy≥0.

The head orientation based image segmentation process 300, at a fourth point in time, performs object segmentation in the focused quadrant. In particular, head orientation based image segmentation process 300 an object (of interest) is segmented in image data 103 (or the divided image data 309) and performs image detection (e.g., on the other targeted region 310). Any available methods for object segmentation and image detection can be used.

### Additional AI Triggers and Head-Orientation Data Based Context Determinations

FIG. 4 illustrates different use cases of an AI assistant using head-orientation data detected at a head-wearable device, in accordance with some embodiments. In particular, FIG. 4 shows detection of head-orientation data and performance of one or more context-based commands based on the head-orientation data and/or a user query. As described above, the head-orientation data is captured by a head-wearable device (e.g., an AR device 728 and/or an MR device 732; FIGS. 7A-7C-2) worn by a user. In some embodiments, the head-wearable device is displayless.

At a first point in time 410, the head-wearable device detects, via one or more sensors (e.g., an IMU), a specific region in a scene that the user is looking at. At a second point in time 415, the head-wearable device uses the one or more sensors to capture head-orientation data that is representative of a user's head orientation in the scene. At a third point in time 420, the head-wearable device and/or the AI system 100, map pitch angles and yaw angles in the head-orientation data to one or more segments and/or regions in image data captured by an imaging device of the head-wearable device. Additional examples of the pitch angles and yaw angles are provided in reference to FIG. 3.

At a fourth point in time 425, the head-wearable device and/or the AI system 100 uses the mapped pitch angles and yaw angles, the image data, and/or additional data captured by the head-wearable device to determine a context-based command. The additional data can include audio data, image data, sensor data, and/or other data captured by the head-wearable device. For example, the AI system 100 and/or the head-wearable device can use audio data of the additional data to identify a verbal query or command. In another example, the AI system 100 and/or the head-wearable device can use image data and/or sensor data of the additional data to detect one or more objects (animate or inanimate) or devices in proximity to the user or in focus of the imaging device.

At a fourth point in time, the AI system 100 and/or the head-wearable device causes performance of one or more context-based commands. The context-based commands correspond to one or more contextual AI usage cases 430.

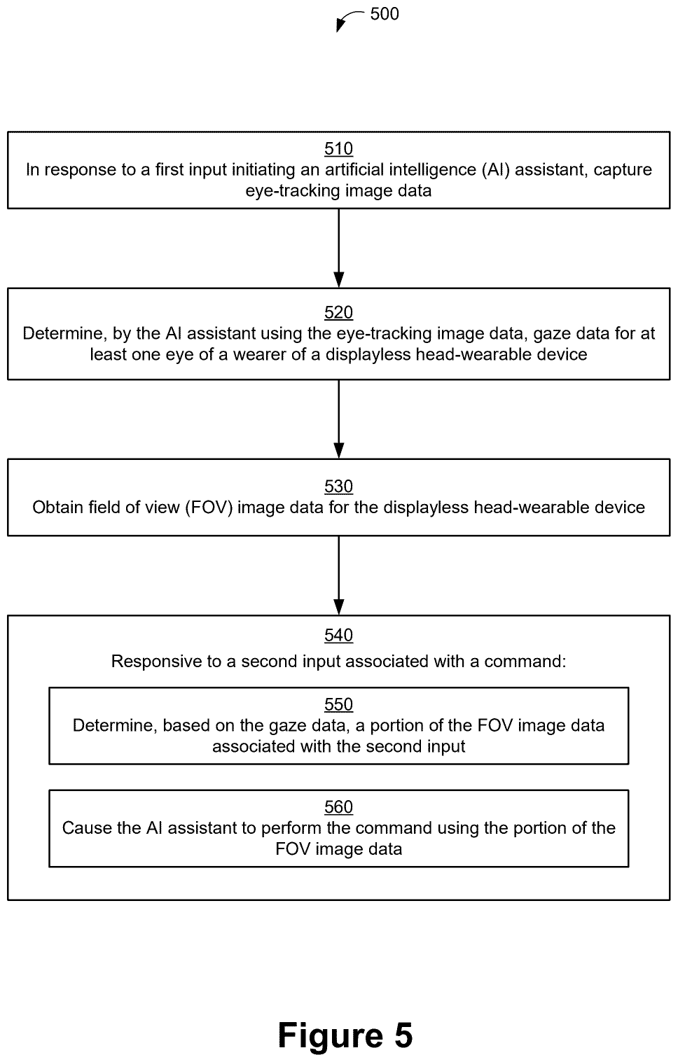

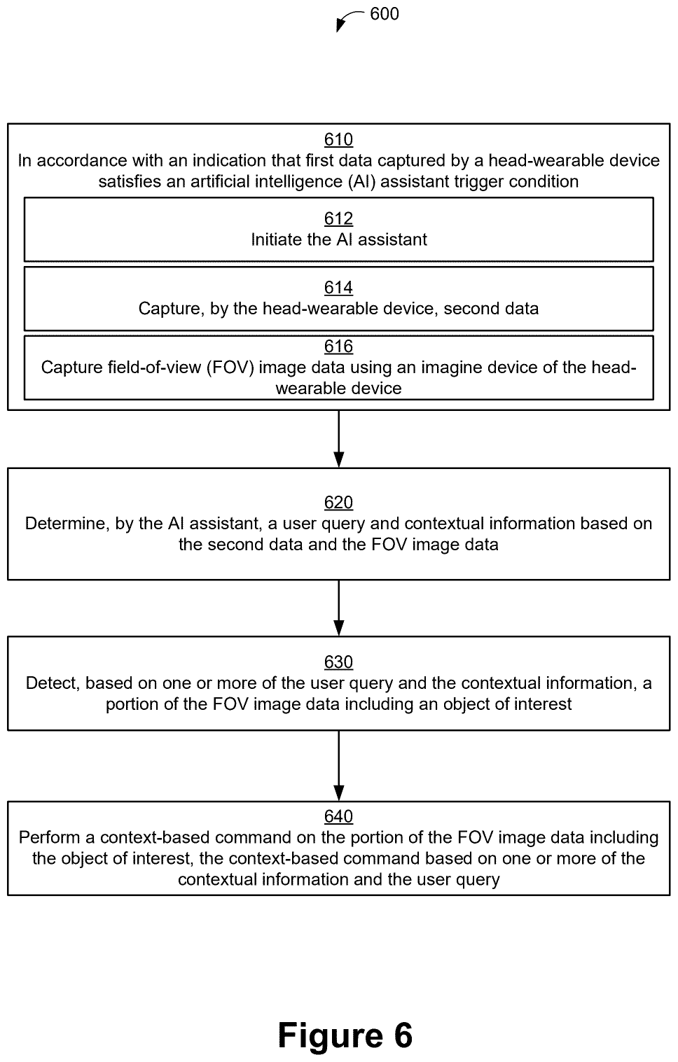

FIGS. 5 and 6 illustrate flow diagrams of a method of using a contextual AI assistant at a head-wearable device, in accordance with some embodiments. Operations (e.g., steps) of the methods 500 and 600 can be performed by one or more processors (e.g., central processing unit and/or MCU) of a system (e.g., AR device 728, MR device 732, and/or other devices described below in reference to FIGS. 7A-7C-2). At least some of the operations shown in FIGS. 5 and 6 correspond to instructions stored in a computer memory or computer-readable storage medium (e.g., storage, RAM, and/or memory). Operations of the method 500 and 600 can be performed by a single device alone or in conjunction with one or more processors and/or hardware components of another communicatively coupled device (e.g., a wrist-wearable device 726, an HIPD 742, a server 730, a computer 740, a mobile device 750, and/or other electronic devices of an XR system described below in reference to FIGS. 7A-7C-2) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.
(A1) FIG. 5 shows a flow chart of a method 500 for using, by an AI assistant, ET data detected at a head-wearable device, in accordance with some embodiments. The method 500 occurs at a head-wearable device (e.g., AR device 728 and/or MR device 732) including one or more imaging devices and sensors. The method 500 includes in response to a first input initiating an AI assistant, capturing (510), via an ET imaging device of a displayless head-wearable device, ET image data. The ET image data can include a representation of an eye-centric scene of a wearer. The method 500 includes determining (520), by the AI assistant using the ET image data, ET data for at least one eye of a wearer of the displayless head-wearable device, and obtaining (530) field of view (FOV) image data for the displayless head-wearable device. The FOV image data can be obtained using a FOV camera for the displayless head-wearable device, which can include a representation of a world-centric scene of the displayless head-wearable device. The method 500 further includes, responsive (540) to a second input associated with a command (e.g., a user query), determining (550), based on the ET data, a portion of the FOV image data associated with the second input, and causing (560) the AI assistant to perform the command using the portion of the FOV image data.
(A2) In some embodiments of A1, the context-based command includes one or more of capturing world-centric scene included in the FOV image data, detecting faces within the portion of the FOV image data, determining contextual information from the portion of the FOV image data, determining reminders from the portion of the FOV image data, determining surface information, detecting objects within the portion of the FOV image data, performing document-specific operations.
(B1) FIG. 6 shows a flow chart of a method 600 for using data captured by the head-wearable device to initiate and use an AI assistant, in accordance with some embodiments. The method 600 occurs at a head-wearable device (e.g., AR device 728 and/or MR device 732) including one or more imaging devices and sensors. The method 600 includes, in accordance with an indication that first data captured by the head-wearable device satisfies (610) an artificial intelligence (AI) assistant trigger condition initiating (612) the AI assistant, capturing (614), by the head-wearable device, second data, and capturing (616) capturing field-of-view (FOV) image data using an imaging device of the head-wearable device. For example, as shown and described in reference to FIGS. 2A-2C and 4, ET data, head-orientation data, audio data, image data, hand-gesture data, and/or touch-input data can be used to initiate or invoke the AI system 100 and capture additional data and image data to be used by the AI system 100.

The method 600 includes determining (620), by the AI assistant, a user query and contextual information based on the second data and the FOV image data. For example, as shown and described in reference to FIGS. 2A-2C and 4, ET data, head-orientation data, audio data, image data, hand-gesture data, and/or touch-input data can be used to determine a user query and/or contextualize the user query based on one or more of the additional data and image data provided to the AI system 100. The method 600 also includes detecting (640), based on one or more of the user query and the contextual information, a portion of the FOV image data including an object of interest. For example, as described in reference to FIGS. 1 and 3, ET data and/or head-orientation data can be used to detect one or more segments of FOV image data that are of interest to a user and process the one or more segments of FOV image data.

The method 600 further includes performing (650) a context-based command on the portion of the FOV image data including the object of interest. The context-based command is based on one or more of the contextual information and the user query. For example, as shown in FIGS. 2A-2C and 4, the context-based command can include any contextual AI usage cases 230 and 430.
(B2) In some embodiments of B1, the context-based command is determined by the AI assistant (e.g., AI system 100; FIGS. 1-4).
(B3) In some embodiments of any one of B1-B2, the first data includes at least one of ET data for at least one eye of a wearer of the head-wearable device captured by an ET module of the head-wearable device, head-orientation data of the wearer of the head-wearable device captured by an inertial measurement unit of the head-wearable device, audio data, image data, hand-gesture data, and touch-input data. For example, the first data can be any one of gaze inputs (or ET data) described in reference to the first trigger 210 in FIGS. 2A and 2B and/or one or more of a voice command, a hand gesture, and/or a device input described in reference to the second trigger 250 in FIG. 2C. Additionally, or alternatively, the first data can be head-orientation data (e.g., orientation angles 420) described in reference to FIG. 4.
(B3.2) In some embodiments of any one of B1-B2, the first data includes ET data and the second data includes audio data. For example, as described above in reference to FIG. 2A, ET data can be used satisfy the first trigger 210 and the first set of inputs 220 can include at least audio data.
(B3.4) In some embodiments of any one of B1-B2, the first data includes first ET data, and the second data includes second ET data. For example, as described above in reference to FIG. 2B, ET data can be used satisfy the first trigger 210 and the second set of inputs 240 can include additional ET data.
(B3.6) In some embodiments of any one of B1-B2, the first data includes an audio input, a device input, and/or a hand gestures, and the second data includes ET data. For example, as described above in reference to FIG. 2C, an audio input, a device input, and/or a hand gesture can be used satisfy the second trigger 250 and the second set of inputs 240 can include additional ET data.
(B3.8) In some embodiments of any one of B1-B3.6, the first data includes head-orientation data, and the second data includes one or more of ET data, audio data, image data, sensor data, hand gesture data, and/or other data. For example, as described above in reference to FIG. 4, head-orientation data can be used by the AI system 100 and additional data captured by the head-wearable device to determine a context-based command.
(B4) In some embodiments of any one of B3-B3.8, the ET data is captured while the ET module is operating in a low-power mode. In some embodiments, the head-wearable device includes ET modules with more than one more modes (e.g., low-power mode and high-power mode). In some embodiments, the head-wearable device includes at least two ET modules—a low-power ET module and high-power ET module. Alternatively, in some embodiments, the head-wearable device includes low-power ET modules for detecting satisfaction of AI assistant trigger conditions and high-power ET modules for other operations.
(B5) In some embodiments of any one of B1-B4, the second data includes one or more of audio data, ET data for at least one eye of a wearer of the head-wearable device captured by an ET module of the head-wearable device, image data, hand-gestures data, head-orientation data of the wearer of the head-wearable device captured by an inertial measurement unit of the head-wearable device, and touch-input data.
(B6) In some embodiments of B5, the ET data of the second data is captured while the ET module is operating in a high-power mode.
(B7) In some embodiments of any one of B1-B6, the context-based command includes one or more of capturing world-centric scene included in the FOV image data; detecting faces within the portion of the FOV image data; determining additional contextual information from the portion of the FOV image data; providing reminders based on the portion of the FOV image data; determining surface information; identifying the object of interest within the portion of the FOV image data; and performing document-specific operations.
(B8) In some embodiments of any one of B1-B7, the head-wearable device is a displayless augmented-reality device.
(B9) In some embodiments of any one of B1-B8, the AI assistant trigger condition include one or more of detection of an eye gesture, detection of an audio command, detection of a hand gesture, and detection of a device input. Examples of the different trigger conditions are provided in reference to FIGS. 2A-2C and 4.
(B10) In some embodiments of any one of B1-B9, the contextual information maps one or more segments of a FOV of an imaging device to one or more of a gaze of a wearer of the head-wearable device and a head orientation of the wearer of the head-wearable device. Examples of different segments and/or regions of a FOV of an imaging device (or FOV image data) are provided in reference to FIGS. 1 and 3.
(B11) In some embodiments of B10, the one or more segments of the FOV of the imaging device incudes at least two segments, a first segment of the one or more segments of the FOV of the imaging device is associated with a first head orientation; and a second segment of the one or more segments of the FOV of the imaging device is associated with a second head orientation. Mapping of one or more segments of image data to head-orientation data is described in reference to FIG. 3.
(B12) In some embodiments of any one of B1-B11, before performing the context-based command on the portion of the FOV image data, segmenting the portion of the FOV image data from the FOV image data such that the portion of the FOV image data is processed independently of the FOV image data. For example, as shown and described above in reference to FIGS. 1 and 3, the image data can be segmented into targeted regions 110 and 310 such that only the targeted regions 110 and 310 need to be processed.
(C1) In accordance with some embodiments, a system that includes a wrist wearable device (or a plurality of wrist-wearable devices) and a pair of augmented-reality glasses, and the system is configured to perform operations corresponding to any of A1-B12.
(D1) In accordance with some embodiments, a non-transitory computer readable storage medium including instructions that, when executed by a computing device in communication with a pair of augmented-reality glasses, cause the computer device to perform operations corresponding to any of A1-B12.
(E1) In accordance with some embodiments, a method of operating a pair of augmented-reality glasses, including operations that correspond to any of A1-B12.
(F1) In accordance with some embodiments, an intermediary processing device (e.g., configured to offload processing operations for a wrist-wearable device and/or a head-worn device) configured to perform or cause performance operations corresponding to any of A1-B12.
(G1) In accordance with some embodiments, a means for performing or causing performance of operations corresponding to any of A1-B12.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

### Example Extended-Reality Systems

FIGS. 7A, 7B, 7C-1, and 7C-2, illustrate example XR systems that include AR and MR systems, in accordance with some embodiments. FIG. 7A shows a first XR system 700a and first example user interactions using a wrist-wearable device 726, a head-wearable device (e.g., AR device 728), and/or a HIPD 742. FIG. 7B shows a second XR system 700b and second example user interactions using a wrist-wearable device 726, AR device 728, and/or an HIPD 742. FIGS. 7C-1 and 7C-2 show a third MR system 700c and third example user interactions using a wrist-wearable device 726, a head-wearable device (e.g., an MR device such as a VR device), and/or an HIPD 742. As the skilled artisan will appreciate upon reading the descriptions provided herein, the above-example AR and MR systems (described in detail below) can perform various functions and/or operations.

The wrist-wearable device 726, the head-wearable devices, and/or the HIPD 742 can communicatively couple via a network 725 (e.g., cellular, near field, Wi-Fi, personal area network, wireless LAN). Additionally, the wrist-wearable device 726, the head-wearable device, and/or the HIPD 742 can also communicatively couple with one or more servers 730, computers 740 (e.g., laptops, computers), mobile devices 750 (e.g., smartphones, tablets), and/or other electronic devices via the network 725 (e.g., cellular, near field, Wi-Fi, personal area network, wireless LAN). Similarly, a smart textile-based garment, when used, can also communicatively couple with the wrist-wearable device 726, the head-wearable device(s), the HIPD 742, the one or more servers 730, the computers 740, the mobile devices 750, and/or other electronic devices via the network 725 to provide inputs.

Turning to FIG. 7A, a user 702 is shown wearing the wrist-wearable device 726 and the AR device 728 and having the HIPD 742 on their desk. The wrist-wearable device 726, the AR device 728, and the HIPD 742 facilitate user interaction with an AR environment. In particular, as shown by the first AR system 700a, the wrist-wearable device 726, the AR device 728, and/or the HIPD 742 cause presentation of one or more avatars 704, digital representations of contacts 706, and virtual objects 708. As discussed below, the user 702 can interact with the one or more avatars 704, digital representations of the contacts 706, and virtual objects 708 via the wrist-wearable device 726, the AR device 728, and/or the HIPD 742. In addition, the user 702 is also able to directly view physical objects in the environment, such as a physical table 729, through transparent lens(es) and waveguide(s) of the AR device 728. Alternatively, an MR device could be used in place of the AR device 728 and a similar user experience can take place, but the user would not be directly viewing physical objects in the environment, such as table 729, and would instead be presented with a virtual reconstruction of the table 729 produced from one or more sensors of the MR device (e.g., an outward facing camera capable of recording the surrounding environment).

The user 702 can use any of the wrist-wearable device 726, the AR device 728 (e.g., through physical inputs at the AR device and/or built-in motion tracking of a user's extremities), a smart-textile garment, externally mounted extremity tracking device, the HIPD 742 to provide user inputs, etc. For example, the user 702 can perform one or more hand gestures that are detected by the wrist-wearable device 726 (e.g., using one or more EMG sensors and/or IMUs built into the wrist-wearable device) and/or AR device 728 (e.g., using one or more image sensors or cameras) to provide a user input. Alternatively, or additionally, the user 702 can provide a user input via one or more touch surfaces of the wrist-wearable device 726, the AR device 728, and/or the HIPD 742, and/or voice commands captured by a microphone of the wrist-wearable device 726, the AR device 728, and/or the HIPD 742. The wrist-wearable device 726, the AR device 728, and/or the HIPD 742 include an artificially intelligent digital assistant to help the user in providing a user input (e.g., completing a sequence of operations, suggesting different operations or commands, providing reminders, confirming a command). For example, the digital assistant can be invoked through an input occurring at the AR device 728 (e.g., via an input at a temple arm of the AR device 728). In some embodiments, the user 702 can provide a user input via one or more facial gestures and/or facial expressions. For example, cameras of the wrist-wearable device 726, the AR device 728, and/or the HIPD 742 can track the user 702's eyes for navigating a user interface.

The wrist-wearable device 726, the AR device 728, and/or the HIPD 742 can operate alone or in conjunction to allow the user 702 to interact with the AR environment. In some embodiments, the HIPD 742 is configured to operate as a central hub or control center for the wrist-wearable device 726, the AR device 728, and/or another communicatively coupled device. For example, the user 702 can provide an input to interact with the AR environment at any of the wrist-wearable device 726, the AR device 728, and/or the HIPD 742, and the HIPD 742 can identify one or more back-end and front-end tasks to cause the performance of the requested interaction and distribute instructions to cause the performance of the one or more back-end and front-end tasks at the wrist-wearable device 726, the AR device 728, and/or the HIPD 742. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 742 can perform the back-end tasks and provide the wrist-wearable device 726 and/or the AR device 728 operational data corresponding to the performed back-end tasks such that the wrist-wearable device 726 and/or the AR device 728 can perform the front-end tasks. In this way, the HIPD 742, which has more computational resources and greater thermal headroom than the wrist-wearable device 726 and/or the AR device 728, performs computationally intensive tasks and reduces the computer resource utilization and/or power usage of the wrist-wearable device 726 and/or the AR device 728.

In the example shown by the first AR system 700a, the HIPD 742 identifies one or more back-end tasks and front-end tasks associated with a user request to initiate an AR video call with one or more other users (represented by the avatar 704 and the digital representation of the contact 706) and distributes instructions to cause the performance of the one or more back-end tasks and front-end tasks. In particular, the HIPD 742 performs back-end tasks for processing and/or rendering image data (and other data) associated with the AR video call and provides operational data associated with the performed back-end tasks to the AR device 728 such that the AR device 728 performs front-end tasks for presenting the AR video call (e.g., presenting the avatar 704 and the digital representation of the contact 706).

In some embodiments, the HIPD 742 can operate as a focal or anchor point for causing the presentation of information. This allows the user 702 to be generally aware of where information is presented. For example, as shown in the first AR system 700a, the avatar 704 and the digital representation of the contact 706 are presented above the HIPD 742. In particular, the HIPD 742 and the AR device 728 operate in conjunction to determine a location for presenting the avatar 704 and the digital representation of the contact 706. In some embodiments, information can be presented within a predetermined distance from the HIPD 742 (e.g., within five meters). For example, as shown in the first AR system 700a, virtual object 708 is presented on the desk some distance from the HIPD 742. Similar to the above example, the HIPD 742 and the AR device 728 can operate in conjunction to determine a location for presenting the virtual object 708. Alternatively, in some embodiments, presentation of information is not bound by the HIPD 742. More specifically, the avatar 704, the digital representation of the contact 706, and the virtual object 708 do not have to be presented within a predetermined distance of the HIPD 742. While an AR device 728 is described working with an HIPD, an MR headset can be interacted with in the same way as the AR device 728.

User inputs provided at the wrist-wearable device 726, the AR device 728, and/or the HIPD 742 are coordinated such that the user can use any device to initiate, continue, and/or complete an operation. For example, the user 702 can provide a user input to the AR device 728 to cause the AR device 728 to present the virtual object 708 and, while the virtual object 708 is presented by the AR device 728, the user 702 can provide one or more hand gestures via the wrist-wearable device 726 to interact and/or manipulate the virtual object 708. While an AR device 728 is described working with a wrist-wearable device 726, an MR headset can be interacted with in the same way as the AR device 728.

Integration of Artificial Intelligence with XR Systems

FIG. 7A illustrates an interaction in which an artificially intelligent virtual assistant can assist in requests made by a user 702. The AI virtual assistant can be used to complete open-ended requests made through natural language inputs by a user 702. For example, in FIG. 7A the user 702 makes an audible request 744 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 7A also illustrates an example neural network 752 used in Artificial Intelligence applications. Uses of Artificial Intelligence (AI) are varied and encompass many different aspects of the devices and systems described herein. AI capabilities cover a diverse range of applications and deepen interactions between the user 702 and user devices (e.g., the AR device 728, an MR device 732, the HIPD 742, the wrist-wearable device 726). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 702 can interact with an AI model through natural language inputs captured by a voice sensor, text inputs, or any other input modality that accepts natural language and/or a corresponding voice sensor module. In another instance, input is provided by tracking the eye gaze of a user 702 via a gaze tracker module. Additionally, the AI model can also receive inputs beyond those supplied by a user 702. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 728) or from multiple devices that are in communication with each other (e.g., a system that includes at least two of an AR device 728, an MR device 732, the HIPD 742, the wrist-wearable device 726, etc.). The AI model can also access additional information (e.g., one or more servers 730, the computers 740, the mobile devices 750, and/or other electronic devices) via a network 725.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 728, an MR device 732, the HIPD 742, the wrist-wearable device 726) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 728, an MR device 732, the HIPD 742, the wrist-wearable device 726), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 742), haptic feedback can provide information to the user 702. An AI model can also use the inputs described above to determine the appropriate modality and device(s) to present content to the user (e.g., a user walking on a busy road can be presented with an audio output instead of a visual output to avoid distracting the user 702).

### Example Augmented Reality Interaction

FIG. 7B shows the user 702 wearing the wrist-wearable device 726 and the AR device 728 and holding the HIPD 742. In the second AR system 700b, the wrist-wearable device 726, the AR device 728, and/or the HIPD 742 are used to receive and/or provide one or more messages to a contact of the user 702. In particular, the wrist-wearable device 726, the AR device 728, and/or the HIPD 742 detect and coordinate one or more user inputs to initiate a messaging application and prepare a response to a received message via the messaging application.

In some embodiments, the user 702 initiates, via a user input, an application on the wrist-wearable device 726, the AR device 728, and/or the HIPD 742 that causes the application to initiate on at least one device. For example, in the second AR system 700b the user 702 performs a hand gesture associated with a command for initiating a messaging application (represented by messaging user interface 712); the wrist-wearable device 726 detects the hand gesture; and, based on a determination that the user 702 is wearing the AR device 728, causes the AR device 728 to present a messaging user interface 712 of the messaging application. The AR device 728 can present the messaging user interface 712 to the user 702 via its display (e.g., as shown by user 702's field of view 710). In some embodiments, the application is initiated and can be run on the device (e.g., the wrist-wearable device 726, the AR device 728, and/or the HIPD 742) that detects the user input to initiate the application, and the device provides another device operational data to cause the presentation of the messaging application. For example, the wrist-wearable device 726 can detect the user input to initiate a messaging application, initiate and run the messaging application, and provide operational data to the AR device 728 and/or the HIPD 742 to cause presentation of the messaging application. Alternatively, the application can be initiated and run at a device other than the device that detected the user input. For example, the wrist-wearable device 726 can detect the hand gesture associated with initiating the messaging application and cause the HIPD 742 to run the messaging application and coordinate the presentation of the messaging application.

Further, the user 702 can provide a user input provided at the wrist-wearable device 726, the AR device 728, and/or the HIPD 742 to continue and/or complete an operation initiated at another device. For example, after initiating the messaging application via the wrist-wearable device 726 and while the AR device 728 presents the messaging user interface 712, the user 702 can provide an input at the HIPD 742 to prepare a response (e.g., shown by the swipe gesture performed on the HIPD 742). The user 702's gestures performed on the HIPD 742 can be provided and/or displayed on another device. For example, the user 702's swipe gestures performed on the HIPD 742 are displayed on a virtual keyboard of the messaging user interface 712 displayed by the AR device 728.

In some embodiments, the wrist-wearable device 726, the AR device 728, the HIPD 742, and/or other communicatively coupled devices can present one or more notifications to the user 702. The notification can be an indication of a new message, an incoming call, an application update, a status update, etc. The user 702 can select the notification via the wrist-wearable device 726, the AR device 728, or the HIPD 742 and cause presentation of an application or operation associated with the notification on at least one device. For example, the user 702 can receive a notification that a message was received at the wrist-wearable device 726, the AR device 728, the HIPD 742, and/or other communicatively coupled device and provide a user input at the wrist-wearable device 726, the AR device 728, and/or the HIPD 742 to review the notification, and the device detecting the user input can cause an application associated with the notification to be initiated and/or presented at the wrist-wearable device 726, the AR device 728, and/or the HIPD 742.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 728 can present to the user 702 game application data and the HIPD 742 can use a controller to provide inputs to the game. Similarly, the user 702 can use the wrist-wearable device 726 to initiate a camera of the AR device 728, and the user can use the wrist-wearable device 726, the AR device 728, and/or the HIPD 742 to manipulate the image capture (e.g., zoom in or out, apply filters) and capture image data.

While an AR device 728 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 7C-1 and 7C-2, the user 702 is shown wearing the wrist-wearable device 726 and an MR device 732 (e.g., a device capable of providing either an entirely VR experience or an MR experience that displays object(s) from a physical environment at a display of the device) and holding the HIPD 742. In the third AR system 700c, the wrist-wearable device 726, the MR device 732, and/or the HIPD 742 are used to interact within an MR environment, such as a VR game or other MR/VR application. While the MR device 732 presents a representation of a VR game (e.g., first MR game environment 720) to the user 702, the wrist-wearable device 726, the MR device 732, and/or the HIPD 742 detect and coordinate one or more user inputs to allow the user 702 to interact with the VR game.

In some embodiments, the user 702 can provide a user input via the wrist-wearable device 726, the MR device 732, and/or the HIPD 742 that causes an action in a corresponding MR environment. For example, the user 702 in the third MR system 700c (shown in FIG. 7C-1) raises the HIPD 742 to prepare for a swing in the first MR game environment 720. The MR device 732, responsive to the user 702 raising the HIPD 742, causes the MR representation of the user 722 to perform a similar action (e.g., raise a virtual object, such as a virtual sword 724). In some embodiments, each device uses respective sensor data and/or image data to detect the user input and provide an accurate representation of the user 702's motion. For example, image sensors (e.g., SLAM cameras or other cameras) of the HIPD 742 can be used to detect a position of the HIPD 742 relative to the user 702's body such that the virtual object can be positioned appropriately within the first MR game environment 720; sensor data from the wrist-wearable device 726 can be used to detect a velocity at which the user 702 raises the HIPD 742 such that the MR representation of the user 722 and the virtual sword 724 are synchronized with the user 702's movements; and image sensors of the MR device 732 can be used to represent the user 702's body, boundary conditions, or real-world objects within the first MR game environment 720.

In FIG. 7C-2, the user 702 performs a downward swing while holding the HIPD 742. The user 702's downward swing is detected by the wrist-wearable device 726, the MR device 732, and/or the HIPD 742 and a corresponding action is performed in the first MR game environment 720. In some embodiments, the data captured by each device is used to improve the user's experience within the MR environment. For example, sensor data of the wrist-wearable device 726 can be used to determine a speed and/or force at which the downward swing is performed and image sensors of the HIPD 742 and/or the MR device 732 can be used to determine a location of the swing and how it should be represented in the first MR game environment 720, which, in turn, can be used as inputs for the MR environment (e.g., game mechanics, which can use detected speed, force, locations, and/or aspects of the user 702's actions to classify a user's inputs (e.g., user performs a light strike, hard strike, critical strike, glancing strike, miss) or calculate an output (e.g., amount of damage)).

FIG. 7C-2 further illustrates that a portion of the physical environment is reconstructed and displayed at a display of the MR device 732 while the MR game environment 720 is being displayed. In this instance, a reconstruction of the physical environment 746 is displayed in place of a portion of the MR game environment 720 when object(s) in the physical environment are potentially in the path of the user (e.g., a collision with the user and an object in the physical environment are likely). Thus, this example MR game environment 720 includes (i) an immersive VR portion 748 (e.g., an environment that does not have a corollary counterpart in a nearby physical environment) and (ii) a reconstruction of the physical environment 746 (e.g., table 750 and cup 752). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 726, the MR device 732, and/or the HIPD 742 are described as detecting user inputs, in some embodiments, user inputs are detected at a single device (with the single device being responsible for distributing signals to the other devices for performing the user input). For example, the HIPD 742 can operate an application for generating the first MR game environment 720 and provide the MR device 732 with corresponding data for causing the presentation of the first MR game environment 720, as well as detect the user 702's movements (while holding the HIPD 742) to cause the performance of corresponding actions within the first MR game environment 720. Additionally or alternatively, in some embodiments, operational data (e.g., sensor data, image data, application data, device data, and/or other data) of one or more devices is provided to a single device (e.g., the HIPD 742) to process the operational data and cause respective devices to perform an action associated with processed operational data.

In some embodiments, the user 702 can wear a wrist-wearable device 726, wear an MR device 732, wear smart textile-based garments 738 (e.g., wearable haptic gloves), and/or hold an HIPD 742 device. In this embodiment, the wrist-wearable device 726, the MR device 732, and/or the smart textile-based garments 738 are used to interact within an MR environment (e.g., any AR or MR system described above in reference to FIGS. 7A-7B). While the MR device 732 presents a representation of an MR game (e.g., second MR game environment 720) to the user 702, the wrist-wearable device 726, the MR device 732, and/or the smart textile-based garments 738 detect and coordinate one or more user inputs to allow the user 702 to interact with the MR environment.

In some embodiments, the user 702 can provide a user input via the wrist-wearable device 726, an HIPD 742, the MR device 732, and/or the smart textile-based garments 738 that causes an action in a corresponding MR environment. In some embodiments, each device uses respective sensor data and/or image data to detect the user input and provide an accurate representation of the user 702's motion. While four different input devices are shown (e.g., a wrist-wearable device 726, an MR device 732, an HIPD 742, and a smart textile-based garment 738) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 738) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 738 can be used in conjunction with an MR device and/or an HIPD 742.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 7A-7C-2 provided above are intended to augment the description provided in reference to FIGS. 1-6. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors of a head-wearable device, cause the head-wearable device to perform:
in accordance with an indication that first data captured by the head-wearable device satisfies an artificial intelligence (AI) assistant trigger condition:
initiating the AI assistant,
capturing, by the head-wearable device, second data, and
capturing field-of-view (FOV) image data using an imaging device of the head-wearable device;
determining, by the AI assistant, i) a user query and ii) contextual information based on the second data and the FOV image data;
detecting, based on one or more of the user query and the contextual information, a portion of the FOV image data including an object of interest, and
performing a context-based command on the portion of the FOV image data including the object of interest, wherein the context-based command is based on one or more of the contextual information and the user query.

2. The non-transitory, computer-readable storage medium of claim 1, wherein before performing the context-based command on the portion of the FOV image data, segmenting the portion of the FOV image data from the FOV image data such that the portion of the FOV image data is processed independently of the FOV image data.

3. The non-transitory, computer-readable storage medium of claim 1, wherein the first data includes at least one of eye-tracking data for at least one eye of a wearer of the head-wearable device captured by an eye tracking module of the head-wearable device, head-orientation data of the wearer of the head-wearable device captured by an inertial measurement unit of the head-wearable device, audio data, image data, hand-gesture data, and touch-input data.

4. The non-transitory, computer-readable storage medium of claim 3, wherein the eye-tracking data is captured while the eye tracking module is operating in a low-power mode.

5. The non-transitory, computer-readable storage medium of claim 1, wherein the second data includes one or more of audio data, eye-tracking data for at least one eye of a wearer of the head-wearable device captured by an eye tracking module of the head-wearable device, image data, hand-gestures data, head-orientation data of the wearer of the head-wearable device captured by an inertial measurement unit of the head-wearable device, and touch-input data.

6. The non-transitory, computer-readable storage medium of claim 1, wherein the context-based command includes one or more of:
capturing world-centric scene included in the FOV image data;
detecting faces within the portion of the FOV image data;
determining additional contextual information from the portion of the FOV image data;
providing reminders based on the portion of the FOV image data;
determining surface information;
identifying the object of interest within the portion of the FOV image data; and
performing document-specific operations.

7. The non-transitory, computer-readable storage medium of claim 1, wherein the head-wearable device is a displayless augmented-reality device.

8. The non-transitory, computer-readable storage medium of claim 1, wherein the AI assistant trigger condition include one or more of detection of an eye gesture, detection of an audio command, detection of a hand gesture, and detection of a device input.

9. The non-transitory, computer-readable storage medium of claim 1, wherein the contextual information maps one or more segments of a FOV of an imaging device to one or more of a gaze of a wearer of the head-wearable device and a head orientation of the wearer of the head-wearable device.

10. The non-transitory, computer-readable storage medium of claim 9, wherein:
the one or more segments of the FOV of the imaging device incudes at least two segments;
a first segment of the one or more segments of the FOV of the imaging device is associated with a first head orientation; and
a second segment of the one or more segments of the FOV of the imaging device is associated with a second head orientation.

11. A head-wearable device, comprising:
an imaging device;
one or more sensors;
one or more programs, wherein the one or more programs are stored in memory and configured to be executed by one or more processors, the one or more programs including instructions for:
in accordance with an indication that first data captured by the head-wearable device satisfies an artificial intelligence (AI) assistant trigger condition:
initiating the AI assistant,
capturing, by the head-wearable device, second data, and
capturing field-of-view (FOV) image data using an imaging device of the head-wearable device;
determining, by the AI assistant, i) a user query and ii) contextual information based on the second data and the FOV image data;
detecting, based on one or more of the user query and the contextual information, a portion of the FOV image data including an object of interest, and
performing a context-based command on the portion of the FOV image data including the object of interest, wherein the context-based command is based on one or more of the contextual information and the user query.

12. The head-wearable device of claim 11, wherein the first data includes at least one of eye-tracking data for at least one eye of a wearer of the head-wearable device captured by an eye tracking module of the head-wearable device, head-orientation data of the wearer of the head-wearable device captured by an inertial measurement unit of the head-wearable device, audio data, image data, hand-gesture data, and touch-input data.

13. The head-wearable device of claim 12, wherein the eye-tracking data is captured while the eye tracking module is operating in a low-power mode.

14. The head-wearable device of claim 11, wherein the context-based command includes one or more of:
capturing world-centric scene included in the FOV image data;
detecting faces within the portion of the FOV image data;
determining additional contextual information from the portion of the FOV image data;
providing reminders based on the portion of the FOV image data;
determining surface information;
identifying the object of interest within the portion of the FOV image data; and
performing document-specific operations.

15. The head-wearable device of claim 11, wherein the head-wearable device is a displayless augmented-reality device.

16. A method, comprising:
in accordance with an indication that first data captured by a head-wearable device satisfies an artificial intelligence (AI) assistant trigger condition:
initiating the AI assistant,
capturing, by the head-wearable device, second data, and
capturing field-of-view (FOV) image data using an imaging device of the head-wearable device;
determining, by the AI assistant, i) a user query and ii) contextual information based on the second data and the FOV image data;
detecting, based on one or more of the user query and the contextual information, a portion of the FOV image data including an object of interest, and
performing a context-based command on the portion of the FOV image data including the object of interest, wherein the context-based command is based on one or more of the contextual information and the user query.

17. The method of claim 16, wherein the first data includes at least one of eye-tracking data for at least one eye of a wearer of the head-wearable device captured by an eye tracking module of the head-wearable device, head-orientation data of the wearer of the head-wearable device captured by an inertial measurement unit of the head-wearable device, audio data, image data, hand-gesture data, and touch-input data.

18. The method of claim 17, wherein the eye-tracking data is captured while the eye tracking module is operating in a low-power mode.

19. The method of claim 16, wherein the context-based command includes one or more of:
capturing world-centric scene included in the FOV image data;
detecting faces within the portion of the FOV image data;
determining additional contextual information from the portion of the FOV image data;
providing reminders based on the portion of the FOV image data;
determining surface information;
identifying the object of interest within the portion of the FOV image data; and
performing document-specific operations.

20. The method of claim 16, wherein the head-wearable device is a displayless augmented-reality device.
